(19) United States
(12) Patent Application Publication
(10) Pub. No.: US 2017/0228178 A1
(43) Pub. Date: Aug. 10, 2017

(54) EFFECTIVE UTILIZATION OF STORAGE ARRAYS WITHIN AND ACROSS DATACENTERS

(71) Applicant: HEWLETT PACKARD ENTERPRISE DEVELOPMENT LP, Houston, TX (US)

(72) Inventors: Sudheer Yetukuri, Bangalore (IN); Thavamaniraja Sakthivel, Bangalore (IN); Swaroop Jayanthi, Bangalore (IN)

(21) Appl. No.: 15/409,838

(22) Filed: Jan. 19, 2017

(30) Foreign Application Priority Data
Feb. 4, 2016 (IN) 201641004054

(51) Int. Cl. G06F 3/06

(52) U.S. Cl. CPC G06F 3/0619; G06F 3/0689; G06F 3/0665; G06F 3/067

(57) ABSTRACT

In one example, a network is described, which includes multiple hosts, multiple storage area network switches, and multiple storage arrays coupled to the multiple hosts via the associated multiple storage area network switches. Further, at least one of the multiple hosts includes a storage resource manager (SRM) including a smart storage data analyzer (SSDA) to automatically collect and analyze storage volume I/O usage and latency and then recommend moving the storage volumes to appropriate logical data tiers.

### BACKGROUND

Wide spread use of social networks and communications have led to exponential data growth and usage of storage disk in storage area networks (SANs) in datacenters. Each SAN in a datacenter may include storage arrays to store data. Storage arrays may include multiple storage pools, each storage pool may include either a set of high performance low capacity storage disks, such as solid state storage devices (SSDs), a set of medium performance medium capacity storage disks, such as fiber channel (FC) storage disks, or a set of low performance high capacity storage disks, such as nearline (NL)/serial AT attachment (SATA) storage disks. In such a scenario, high performance low capacity storage disks may be significantly more expensive to use than low performance high capacity storage disks.

### BRIEF DESCRIPTION OF THE DRAWINGS

Examples are described in the following detailed description and in reference to the drawings, in which:

FIG. 1 is an example block diagram showing a system for effective utilization of storage arrays within and across datacenters, according to one aspect of the present subject matter;

FIG. 2 illustrates an example block diagram showing data movement across storage arrays in a datacenter, such as those shown in FIG. 1, according to one aspect of the present subject matter;

FIG. 3 shows an example generated table including inventory of available storage arrays in a datacenter, such as those shown in FIGS. 1 and 2, according to one aspect of the present subject matter;

FIG. 4 shows another example generated table including recommendations for moving storage volumes based on Input/Output (I/O) usage in a datacenter, such as those shown in FIGS. 1 and 2, according to one aspect of the present subject matter;

FIG. 5 is an example flowchart of a process for effective utilization of storage arrays within and across datacenters, such as those shown in FIGS. 1 and 2, according to one aspect of the present subject matter;

FIG. 6 is an example flowchart of a process for collecting the performance and capacity usage of the storage disk based on the unique universal identifier (UUID) and updating inventory table associated with the storage disks; and

FIG. 7 is a block diagram of an example system for effective utilization of storage arrays within and across datacenters, such as those shown in FIGS. 1 and 2.

### DETAILED DESCRIPTION

Increasing use of social networks and various other communications via mobile and electronic devices has resulted in exponential data growth. Such data may reside in heterogeneous storage arrays in SANs located across multiple datacenters. Heterogeneous storage array may include high performance low capacity, medium performance medium capacity, and/or high capacity low performance storage disks. High performance low capacity storage disks may be significantly more expensive to use than low performance high capacity storage disks. In datacenters usage of stored data may vary with time, i.e., as the stored data ages the I/O activity associated with the stored data may also significantly reduce.

To address these issues, the present specification describes various examples for effective utilization of heterogeneous storage arrays in datacenters to optimize cost and improve performance associated with storing and retrieving data. In an example, the proposed solution automatically collects and analyses storage volume I/O usage and latency and recommends moving the storage volumes to appropriate logical data tiers within and across heterogeneous storage arrays in datacenters, which in turn facilitates ease and effective storage data movement and reduce storage costs based on usage.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

The terms “storage” and “storage disk” may be used interchangeably throughout the document. Also, the terms “network” and “storage area network” may be used interchangeably throughout the document. Further, the terms “volume” and “storage volume” are being used interchangeably throughout the document.

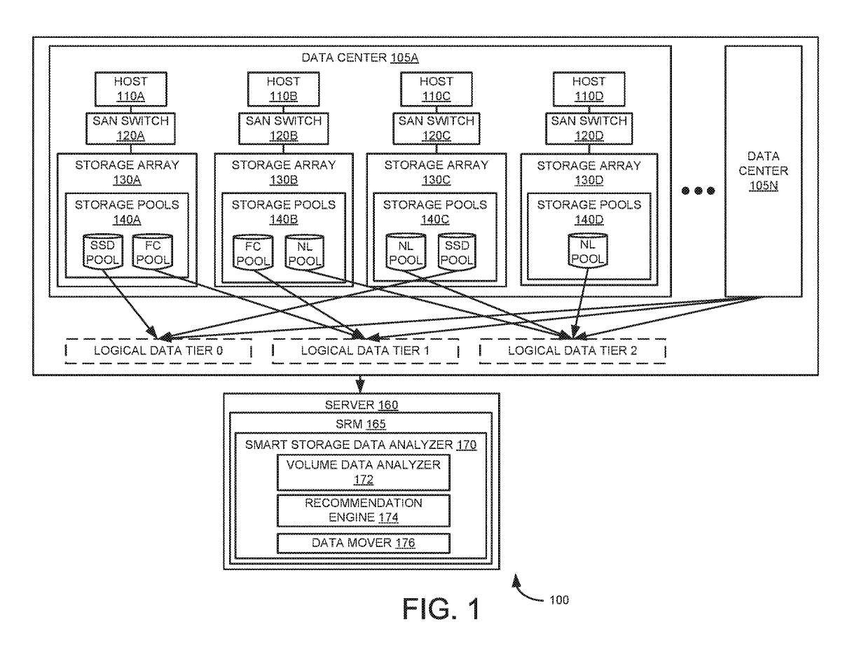

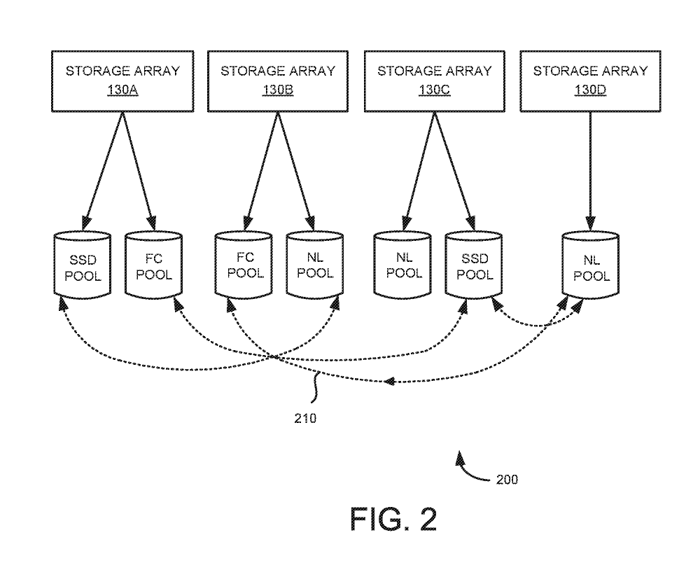

Turning now to the figures, FIG. 1 illustrates an example block diagram of storage arrays 130A-D and their connectivity in multiple datacenters 105A-N in a network 100, according to one aspect of the present subject matter. As shown in FIG. 1, each of multiple datacenters 105A-N comprise multiple hosts 110A-D, multiple storage area network (SAN) switches 120A-D, and multiple storage arrays 130A-D. Also as shown in FIG. 1, multiple hosts 110A-D may be communicatively coupled to the multiple storage arrays 130A-D via associated multiple SAN switches 120A-D. Further as shown in FIGS. 1 and 2, each of the multiple storage arrays 130A-D may be communicatively coupled to each other within and across the multiple datacenters 105A-N.

Furthermore, as shown in FIG. 1, each of the multiple storage arrays 130A-D may include associated storage pools 140A-D. Example, storage pools 140A-D may include homogeneous storage pools and heterogeneous storage pools. In an example, storage pool may be created based on the architecture of a storage disk (i.e., a disk based storage pool). For example, each heterogeneous storage pool may include a set of high performance low capacity storage disks (SSD pool), a set of medium performance medium capacity storage disks (FC pool), or a set of low performance high capacity storage disks (NL pool). Example high performance low capacity storage disk may include a solid state storage device (SSD), the medium performance medium capacity storage device may include a fiber channel (FC) storage disks, and the low performance high capacity storage disk may include a nearline (NL)/serial AT attachment (SATA) storage disks.

In addition, as shown in FIG. 1, a server 160 including a storage resource manager (SRM) 165 that is communicatively coupled to each of the multiple datacenters 105A-N. The SRM (and components thereof) may be implemented as a combination of hardware and programming, for example in the form of a processor and machine-readable instructions. In an example, the SRM 165 may include a smart storage data analyzer 170, which in-turn may include a volume data analyzer 172, a recommendation engine 174 and a data mover 176. Even though the SRM 165 in FIG. 1 is shown as being hosted by an external server 160, the SRM 165 including the smart storage data analyzer 170 may be hosted in one of the multiple hosts 110A-D in the datacenters 105A-N.

In an example operation, the smart storage data analyzer (SSDA) 170 discovers SAN devices in each of the multiple data centers 105 in the network 100. In an example, the SAN devices may include multiple hosts 110A-D, multiple SAN switches 120A-D, and multiple storage arrays 130A-D. Also in an example, each of multiple storage arrays 130A-D may include at least one of storage pools 140A-D, In an example, the SSDA 170 may discover some or all of the SAN devices present in each of the multiple datacenters 105A-N via a SRM database in the network 100.

Further in the example operation, the SSDA 170 may determine a SAN connectivity path tree of some or all discovered SAN devices within and across the multiple datacenters 105A-N in the network 100. In an example, the SSDA 170 may determine a connectivity path tree. The term “connectivity path tree” may refer to any mapping of communication links between a source SAN device and a target SAN device. For example, the determined connectivity path tree between a source to a target may look as follows:
Initiator Port=>Switch Ports=>Target Port
Wherein,
Initiator Port=Host Bus Adapter Port World Wide Number,
Target Port=>Storage System Controller Port World Wide Number, and
Switch Ports=>Switch Ports where Initiator Ports and Target Ports are connected.

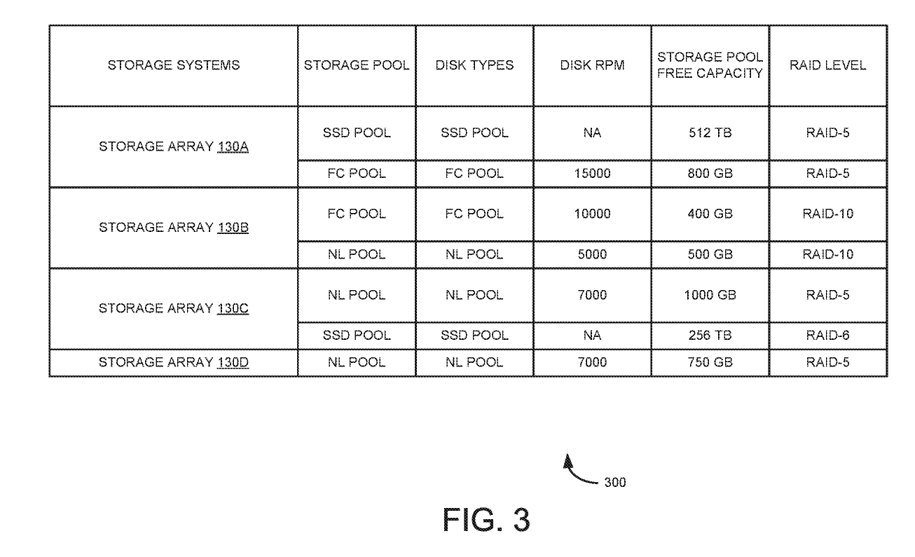

The SSDA 170 may then retrieve metadata associated with each of the storage pools 140A-D in the multiple storage arrays 130A-D in the multiple datacenters 105A-N. In an example, the SSDA 170 may obtain the metadata associated with each storage pool from an SRM inventory table. Example metadata may include storage pool universal unique identifier (UUID), disk UUID, disk type, revolutions per minute (RPM), redundant array of inexpensive disks (RAID) level, storage pool capacity in gigabytes (GB), storage controller worldwide port name (WWPN), and/or storage array name. As one particular example, FIG. 3 shows a table 300 including example metadata of storage disks associated with storage arrays 130A-D obtained from the SRM persistent inventory. The term “SRM persistent inventory” and “SRM inventory table” may be used interchangeably throughout the document.

The SSDA 170 may then create logical data tiers 0-2 (shown in FIG. 1) based on the retrieved metadata associated with each storage pool residing in the multiple storage arrays 130A-D in the multiple datacenters 105A-N. In an example, the SSDA 170 may create logical data tiers 0-2 based on pool type, RPM and/or RAID level. Further in an example, the SSDA 170 may create logical data tiers 0 including each of SSD pools in each of storage arrays 130A-D, logical data tier 1 including each of FC pools in each of the storage arrays 130A-D and so on. The SSDA 170 may then map storage volumes within each storage pool to created logical data tiers 0-2 as shown in FIG. 1, In an example, storage pools may be divided into storage volumes. Storage volumes are often configured based on size, drive letter or folder, file system, allocation unit size, and/or optional volume label. Logical data tiers may include multiple storage volumes, including storage volumes from different storage arrays.

Below is an example implementation of above described creation of logical data tiers 0-2 and mapping of the storage volumes:
1) Build a map with storage disk and associated storage volumes across the storage arrays. Map<Disk_UUID, DiskVO>diskInventory;

DiskVO {

disk_uuid,
Map<Volume_ID, VolumeVO>
disk_rpm;
disk_raid_level;
disk_capacity;
disk_type;
storage_array_uuid;
disk_performance_counters;
disk_capacity_usage;

}

2) Create a logicaldatatier object in SRM inventory across arrays.
   a) Scan the diskInventoty map and create logicaldatatier based on the disk_type and disk_raid_level.
   b) Construct a Map for logicaldatatier objects. Map<logicaldatatier_uuid, List<DiskVO>>logicaldatatiermap;
   c) And tag each logicaldatatier object with disk_type & disk_rpm.

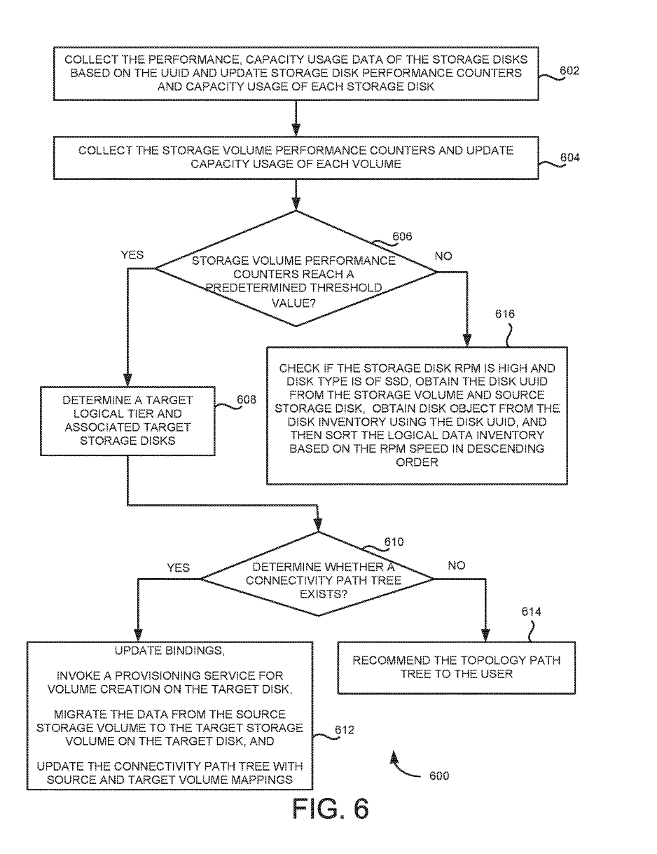

The volume data analyzer 172 may then analyze each storage volume input/output (I/O) usage and associated latency within and across datacenters 105A-N. An example process of storage volume I/O usage and associated latency analysis is presented below in FIG. 6.

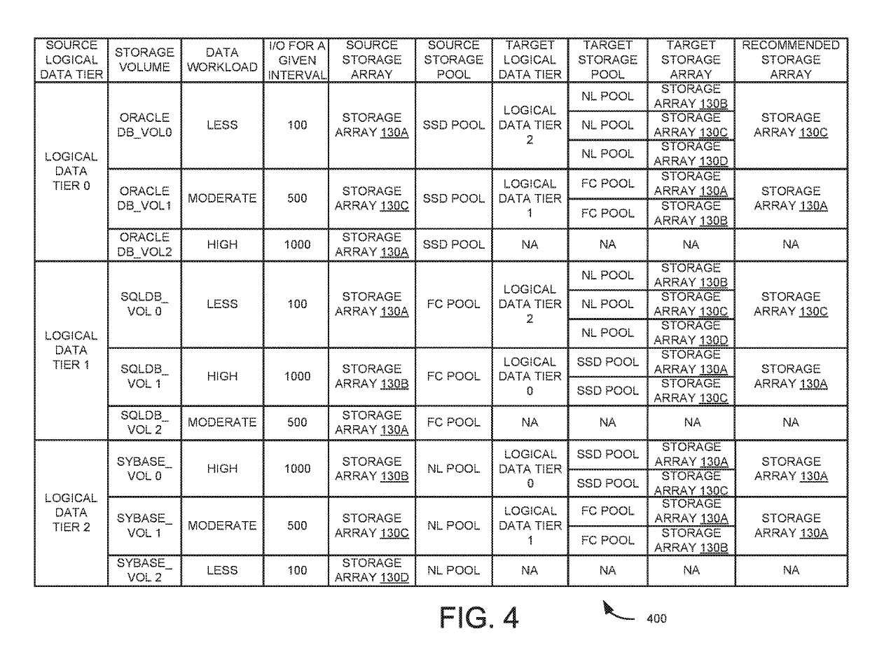

As shown in FIG. 1, the recommendation engine 174 may then recommend another one of the created logical data tiers for storing volumes based on the analyzed storage volume I/O usage. In an example, the recommendation engine 174 may determine the device connectivity associated with each storage volume based on the analysis storage volume I/O usage and latency information obtained from the volume data analyzer 172. The recommendation engine 174 may then recommend a logical data tier for storing each storage volume based on the determined SAN connectivity and analyzed storage volume I/O usage and latency. FIG. 4 shows an example recommendation report (e.g., 400) generated by the recommendation engine 174.

In the example shown in FIG. 4, storage volume “ORACLE DB_VOL0” is stored within source storage pool “SSD POOL” of the storage array 130 A. Further, the “SSD POOL” may be mapped to a logical data tier 0. Further, the I/O usage of the SSD pool in the storage array for a given interval may be 100. The I/O usage may be considered as less based on a threshold value. In this instance, a logical data tier 2 may be recommended for storing the storage volume “ORACLE DB_VOL0”. As shown in FIG. 4, the logical tier 2 may be mapped to NL POOL, and hence the storage volume “ORACLE DB_VOL0” can be moved to any of the NL pools in the storage arrays 130B, 130C and 130D based on storage availability. In the example shown in FIG. 4, the storage volume “ORACLE DB_VOL0” is moved to the NL pool in the storage array 130C. Similarly, the storage volumes associated with other storage pools (e.g., NL pool, FC pool, and the like) can be moved to different storage pools across the storage arrays as shown in FIG. 4.

One example of recommendation engine implementation or feature that the recommendation engine 174 may be recommending logical data tier based on the connectivity path. This may include checking for less utilized storage volumes placed on a high cost logical data tier. Based on the outcome of checking if less utilized storage volumes are placed on the high cost logical data tier, then the recommendation engine 174 finds and recommends appropriate local tier across logical data tiers by considering disk revolutions per minute (RPM) speed, storage pool capacity and/or redundant array of inexpensive disk (RAID) level. Further, the recommendation engine 174 may check if there are any heavily utilized storage volumes that are on the low performance logical data tiers. Based on the outcome of the checking, if there are any heavily utilized volumes that are on the low performance logical data tier, then the recommendation engine 174 may find and recommend appropriate high performance logical data tier across the logical data tiers by considering storage disk RPM, storage pool capacity and/or RAID level to move the heavily utilized storage volumes.

The data mover 176 may then dynamically move the storage volumes to the recommended logical data tiers. In one example, the data mover 176 may determine whether the connectivity path exists from the storage volumes to the target logical data tier where the data can be moved in a non-disruptive approach. For example, data mover 176 may check if an initiator port is physically connected to a target storage pool recommended by the recommendation engine 174. If the connectivity path exists, data mover 176 may then migrate the data from source storage volume to the target storage volume on a different logical data tier by performing the provisioning operations. If the connectivity path does not exist, the data mover 176 may recommend the user to have physical connection between initiator port and the target storage arrays/target storage pools and then rerun to checking.

FIG. 2 illustrates an example block diagram showing how the proposed solution achieves data movement 210 across storage arrays in a datacenter, such as those shown in FIG. 1 for effective utilization of the storage arrays in a storage area network (SAN) within and across datacenters in a network. For example, based on the analysis, the SSDA 170 may determine that a storage volume residing in FC disk drive in storage array 130A has a heavy I/O usage (e.g., I/O usage that exceeds a usage threshold). The SSDA 170 may then recommend moving the storage volume from FC Pool to SSD pool located in storage array 130C to improve performance. This change in data movement is shown in FIG. 2 as dotted lines 210. Similarly, based on the analysis, SSDA 170 may determine that a storage volume residing in SSD pool in the storage array 130A does not have a heavy I/O usage, the SSDA 170 may then recommend moving the storage volume from SSD pool in storage array 130A to NL pool located in either one of the 3 storage array's 130B, 130C and 130 D based on availability of storage space to reduce cost of storing the storage volume as the storage volume may not need a high performance disk drive, such as SSD.

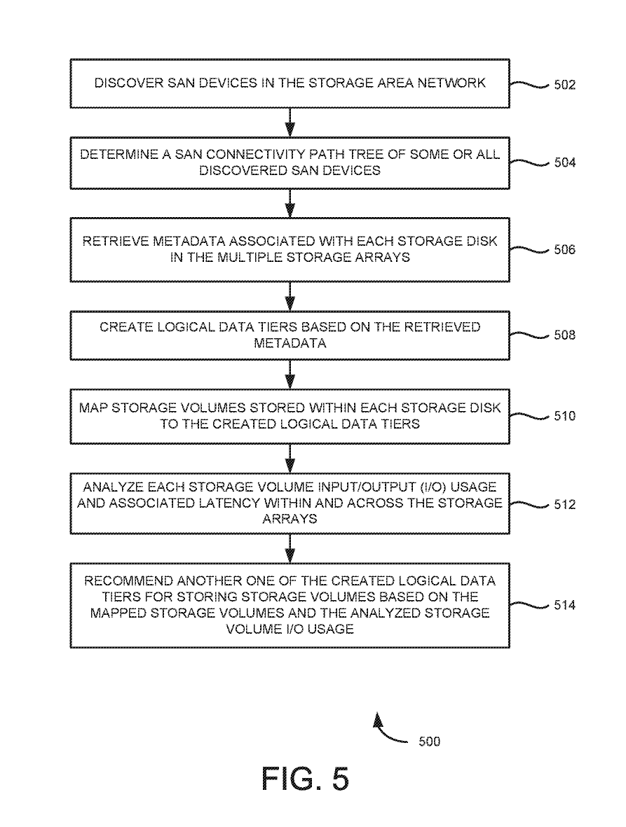

FIG. 5 is a flowchart of an example method 500 for effective utilization of storage arrays within and across datacenters. The method 500, which is described below, may at least partially be executed on a storage system, for example, network 100 of FIG. 1 or storage system 200 of FIG. 2. However, other computing devices may be used as well. At block 502, SAN devices in storage area network in each datacenter may be discovered. The SAN devices may include at least one host, at least one storage area network switch, and multiple storage arrays. Further, each storage array may include at least one storage disk.

At block 504, a SAN connectivity path tree of some or all discovered SAN devices within and across the datacenters in the network may be determined. At block 506, metadata associated with each storage disk in the multiple storage arrays may be retrieved. At block 508, logical data tiers based on the retrieved metadata may be created. At block 510, storage volumes stored within each storage disk may be mapped to created logical data tiers. At block 512, each storage volume input/output (I/O) usage and associated latency of the storage arrays within and across the datacenters may be analyzed. At block 514, another one of the created logical data tiers may be recommended for storing storage volumes based on the created logical data tiers, the mapped storage volumes and/or the analyzed storage volume I/O usage.

FIG. 6 illustrates an example flowchart 600 illustrating an implementation for analyzing each storage volume I/O usage and associated latency (i.e., example implementation showing collecting the performance and capacity usage of the storage disk based on the unique universal identifier (UUID) and update inventory table associated with the storage disks). The volume data analyzer 172 may implement or perform the flowchart 600, for example.

At 602, the volume data analyzer 172 may iterate through a storage disk inventory in the SAN to collect the performance and capacity usage data of the storage disks, e.g., based on UUID. The volume data analyzer 172 may also update storage disk performance counters and capacity usage of each storage disk.

At 604, the volume data analyzer 172 may iterate through each storage volume stored within the storage disks to collect the storage volume performance counters and to update capacity usage of each volume.

At 606, a check is made to determine whether storage volume performance counters reach (e.g., greater than or equal to) a predetermined threshold value. If the storage volume performance counters reach the predetermined threshold value, then a target logical tier and associated target storage disks are determined at 608. In one example, the storage disks may be determined by obtaining the disk UUID from the storage volume and the source storage disk, obtaining disk object, such as disk type, disk RAID, disk RPM, may from disk inventory using the disk UUID, obtaining a target logical data tier associated with the storage volume based on the disk type, disk RAID, and disk RPM and then determining the target storage disks that are mapped to the target logical data tier.

For example, the volume data analyzer 172 may select a target logical tier and associated target storage disks that have a lesser I/O usage (e.g., with performance counters that have not exceeded the predetermined threshold). The volume data analyzer 172 may select the target logical data tier (and associated target storage disks) from any such appropriate logical data tiers randomly, in a round-robin manner, or according to various other selection schemes.

At 610, a check is made to determine whether a connectivity path tree exists from the storage volumes to the target logical data tier where the data can be moved. In one example, the storage pool capacity of the source storage disk is less than the storage pool capacity of the target storage disk.

If the connectivity path exists, at 612 the bindings are updated, a provisioning service is invoked for volume creation on the target disk, the data is migrated from the source storage volume to the target storage volume on the target disk and then the connectivity path tree may be updated with source and target volume mappings upon migration of the source storage volume. If the connectivity path does not exist in the connectivity path tree, then the connectivity path tree is recommended to the user at 614.

At 616, if the storage volume performance counters do not reach the predetermined threshold value, then it is checked if the storage disk RPM is high and disk type is of SSD. When the storage disk RPM is high and disk type is of SSD then the disk UUID is obtained from the storage volume and source storage disk, the disk object is obtained from the disk inventory using the disk UUID, and the logical data inventory is sorted based on the RPM speed in descending order.

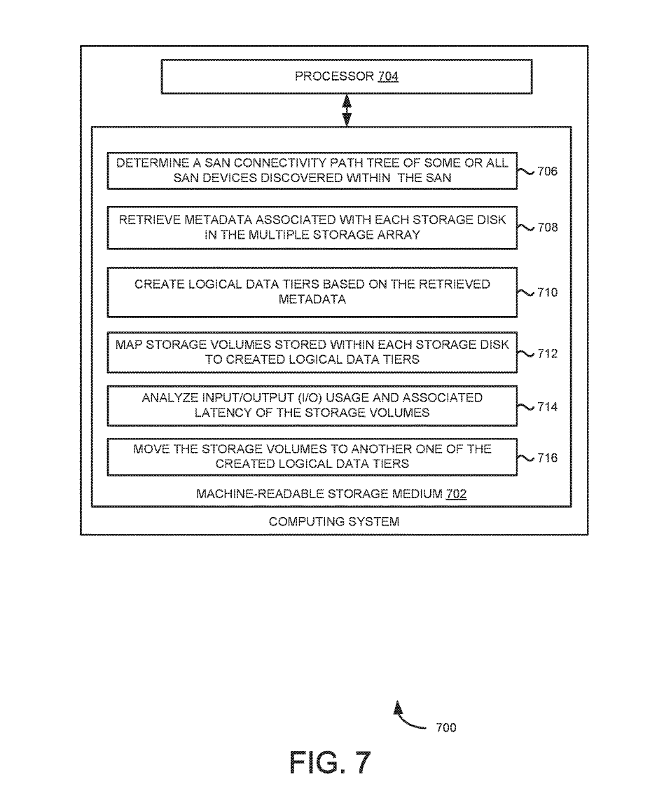

FIG. 7 is a block diagram of an example system 700 for effective utilization of storage arrays within and across datacenters. System 700 includes a processor 704 and a machine-readable storage medium 702 communicatively coupled through a system bus. In an example, system 700 may be analogous to network of FIG. 1 or storage system 200 of FIG. 2. Further, in FIG. 2, it can be seen an example connectivity 210 between storage arrays 130A-D within and across datacenters. Processor 704 may be any type of Central Processing Unit (CPU), microprocessor, or processing logic that interprets and executes machine-readable instructions stored in machine-readable storage medium 702. Machine-readable storage medium 702 may be a random access memory (RAM) or another type of dynamic storage device that may store information and machine-readable instructions that may be executed by processor 704. For example, machine-readable storage medium 702 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 702 may be a non-transitory machine-readable medium. Machine-readable storage medium 702 may store instructions 706, 708, 710, 712, 714, and 716. In an example, instructions 706, 708, 710, 712, 714, and 716 may be executed by processor 704 to effectively utilize storage arrays within and across datacenters.

The example devices, systems, and methods described through FIGS. 1-7 may analyze the data usage across the storage arrays within and across datacenters and may recommend proactively moving data to appropriate logical data tiers. The example devices, systems, methods described through FIGS. 1-7 may also enhance performance and reduce storage cost of the datacenters by effective utilization of storage arrays in the datacenter. The example devices, systems, methods described through FIGS. 1-7 may dynamically move data to appropriate logical data tiers and thus significantly reducing user interventions. Further, implementation of the example devices, systems, methods described through FIGS. 1-7 may be easier to adapt and enhance performance in virtual and cloud environments. Furthermore, the example devices, systems, methods described through FIGS. 1-7 may be easier to adapt in any SRM.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on,” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

We claim:

1. A network, comprising:
multiple hosts;
multiple storage area network switches; and
multiple storage arrays coupled to the multiple hosts via the associated multiple storage area network switches, wherein each storage array comprises at least one storage pool, each storage pool including multiple storage volumes, and wherein at least one of the multiple hosts comprises a storage resource manager (SRM) including a smart storage data analyzer (SSDA), and wherein the SSDA is to:
automatically collect and analyze input/output (I/O) usage and latency of the multiple storage volumes; and
recommend moving at least some of the multiple storage volumes to appropriate logical data tiers within and across storage arrays based on the analysis.

2. The network of claim 1, wherein the SSDA is further to:
discover storage area network (SAN) devices in the network, wherein the SAN devices comprise at least one host, at least one storage area network switch, multiple storage arrays and wherein each storage array comprises at least one storage disk;
determine a SAN connectivity path tree of some or all of the discovered SAN devices;
retrieve metadata associated with each storage disk in the multiple storage arrays;
create logical data tiers based on the retrieved metadata;
map storage volumes stored within each storage disk to the created logical data tiers, wherein each storage volume I/O usage and associated latency are analyzed using the mapped storage volumes, and wherein another one of the created logical data tiers is recommended for storing storage volumes based on the created logical data tiers, the mapped storage volumes, and the analyzed storage volume I/O usage.

3. The network of claim 1, wherein the storage pool of the storage arrays comprises a high performance low capacity storage disk, a medium performance medium capacity storage disk, and/or a low performance high capacity storage disk.

4. The network of claim 3, wherein the high performance low capacity storage disk comprises a solid state storage device (SSD), wherein the medium performance medium capacity storage disk comprises a fiber channel (FC) storage disk, and wherein the low performance high capacity storage disk comprises a nearline (NL)/serial AT attachment (SATA) storage disk.

5. The network of claim 1, wherein the SSDA is further to:
determine SAN connectivity associated for each storage volume based on the analyzed storage volume I/O usage and latency; and
recommend a logical data tier for storing each storage volume based on the determined SAN connectivity and the analyzed storage volume I/O usage and latency.

6. The network of claim 1, wherein the SSDA is further to:
move the storage volumes based on the recommended logical data tiers.

7. A method, comprising:
discovering storage area network (SAN) devices in the storage area network, wherein the SAN devices comprise at least one host, at least one storage area network switch, multiple storage arrays and wherein each storage array comprises at least one storage disk;
determining a SAN connectivity path tree of some or all of the discovered SAN devices;
retrieving metadata associated with each storage disk in the multiple storage arrays;
creating logical data tiers based on the retrieved metadata;
mapping storage volumes stored within each storage disk to the created logical data tiers;
analyzing each storage volume input/output (I/O) usage and associated latency within and across the storage arrays; and
recommending another one of the created logical data tiers for storing storage volumes based on the mapped storage volumes and the analyzed storage volume I/O usage.

8. The method of claim 7, wherein the storage disk comprises combination of at least storage disks selected from the group consisting of a high performance low capacity storage disk, a medium performance medium capacity storage disk, and/or a low performance high capacity storage disk.

9. The method of claim 8, wherein the high performance low capacity storage disk comprises a solid state storage device (SSD), wherein the medium performance medium capacity storage disk comprises a fiber channel (FC) storage disk, and wherein the low performance high capacity storage disk comprises a nearline (NL)/serial AT attachment (SATA) storage disk.

10. The method of claim 7, wherein retrieving the metadata associated with each storage disk from associated array comprises:
retrieving the metadata associated with each storage disk from associated array and storing in a storage resource management (SRM) inventory table.

11. The method of claim 7, wherein the metadata associated with each storage disk comprises disk type, disk universal unique identifier (UUID), storage pool UUID, revolutions per minute (RPM), storage pool capacity in gigabytes (GB), storage controller worldwide port name (WWPN), storage array name, and/or redundant array of inexpensive disks (RAID) level.

12. The method of claim 7, wherein recommending another one of the created logical data tiers for storing the storage volumes, comprises:
determining SAN connectivity associated for each storage volume based on the analyzed storage volume I/O usage and latency; and
recommending another one of the created logical data tiers for storing each storage volume based on the determined SAN connectivity and analyzed storage volume I/O usage and latency.

13. The method of claim 7, further comprising:
moving the storage volumes based on the recommended another one of the created logical data tiers.

14. A non-transitory machine-readable storage medium comprising instructions for effective utilization of storage arrays in a storage area network (SAN), the instructions executable by a processor to:
determine a SAN connectivity path tree of some or all SAN devices discovered within the SAN, wherein each SAN device comprises at least one host, at least one storage area network switch, multiple storage arrays and wherein each storage array comprises at least one storage disk;
retrieve metadata associated with each storage disk in the multiple storage arrays;
create logical data tiers based on the retrieved metadata;
map storage volumes stored within each storage disk to the created logical data tiers;
analyze input/output (I/O) usage and associated latency of the storage volumes; and
move the storage volumes to another one of the created logical data tiers based on the mapped storage volumes and the analyzed I/O usage.

15. The non-transitory machine-readable storage medium of claim 14, further comprising instructions to:
determine SAN connectivity associated for each storage volume based on the analyzed storage volume I/O usage and latency; and
recommend a logical data tier for storing each storage volume based on the determined SAN connectivity and analyzed storage volume I/O usage and latency.
